(19) United States
(12) Patent Application Publication
(10) Pub. No.: US 2016/0124469 A1
(43) Pub. Date: May 5, 2016

(54) DIGITAL BUSINESS CARD

(71) Applicants: Kareem L. Frazier, Douglassville, PA (US); Philip R. Hall, Ottsville, PA (US)

(72) Inventors: Kareem L. Frazier, Douglassville, PA (US); Philip R. Hall, Ottsville, PA (US)

(21) Appl. No.: 14/927,036

(22) Filed: Oct. 29, 2015

Related U.S. Application Data
(60) Provisional application No. 62/073,119, filed on Oct. 31, 2014.

(51) Int. Cl. G06F 1/16; G09G 3/36; G06F 3/14; G06F 3/041

(52) U.S. Cl. CPC G06F 1/1698; G06F 3/0412; G06F 1/1626; G06F 1/1632; G06F 1/1635; G06F 1/1688; G09G 3/36; G06F 3/14; G09G 2380/04

(57) ABSTRACT

An all-inclusive, electronic digital business card with the capability to continuously receive updated and current information. The card includes such things as sales and other business updates, time, weather, website information which contemporaneously changes as circumstances change, current news, and different email addresses. The card has lettering, numbers, and pictures which light up. It contains photo images and has video and audio capabilities. There is no limit to what could be included on the card, including the ability to translate or change to different languages as needed.

### RELATED APPLICATION

This application claims the benefit of provisional application Ser. No. 62/073119, filed on Oct. 31, 2014.

### BACKGROUND OF THE INVENTION

There are various electronic business cards which retrieve, organize and store data. Such systems routinely utilize a portable card reader, which, when used in conjunction with a computer system, receives, organizes, categorizes, and stores business card information. However, these prior cards are generally cumbersome, bulky, and thus not easily carried on one's person. Most significantly, existing electronic cards do not have the capability to efficiently and effectively, receive and process, up-to-date data, from outside sources, and then clearly display this data on a readily portable business card.

### SUMMARY OF THE INVENTION

The present invention comprises an all-inclusive, electronic digital business card with the capability to continuously receive updated and current information. The card includes such things as sales and other business updates, time, weather, website information which contemporaneously changes as circumstances change, current news, and different email addresses. The card has lettering, numbers, and pictures which light up. It contains photo images and has video and audio capabilities. There is no limit to what could be included on the card, including the ability to translate or change to different languages as needed.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an exploded view of the components of the digital business card of the present invention.

FIG. 2 is a front view of the digital business card of the present invention in its powered-off state.

FIG. 3 is a rear view of the digital business card of the present invention.

FIG. 4 is a schematic illustrating the operation of the digital business card of the present invention.

FIG. 5 is a front perspective view of a representation of the digital business card of the present invention in use.

FIG. 6 is the front view of a representation of the screen of the digital business card of the present invention in use.

### DETAILED DESCRIPTION OF THE INVENTION

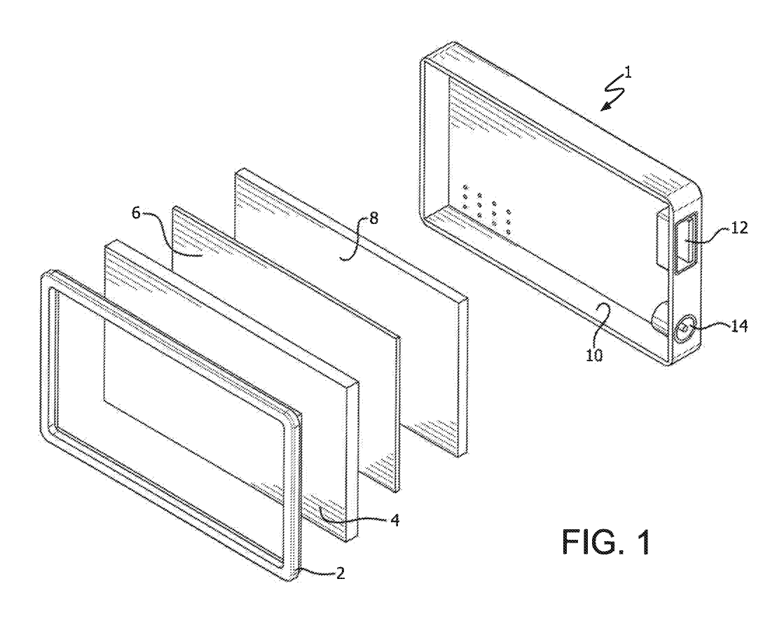

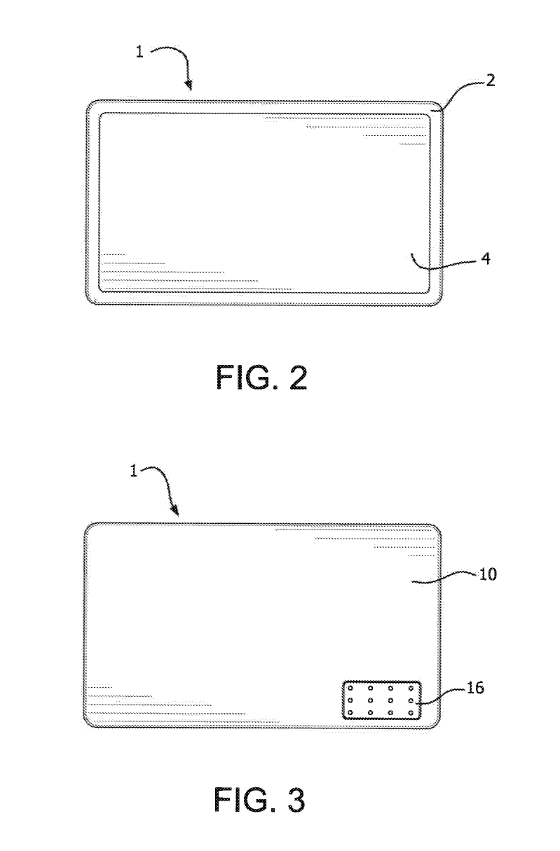

FIGS. 1-3 show the main components of digital business card 1 of the present invention. Specifically, card 1 comprises front housing 2 overlaying LCD touchscreen 4, which overlays application processor 6. Power system 8, including lithium-ion battery 46 or equivalent power supply, and a battery management system 48 is provided behind processor 6 to supply the requisite electrical power. Rear housing 10 supports front housing 2, touchscreen 4, processor 6, and power system 8. Rear housing also includes USB port 12, charging port 14, and audio speaker 16.

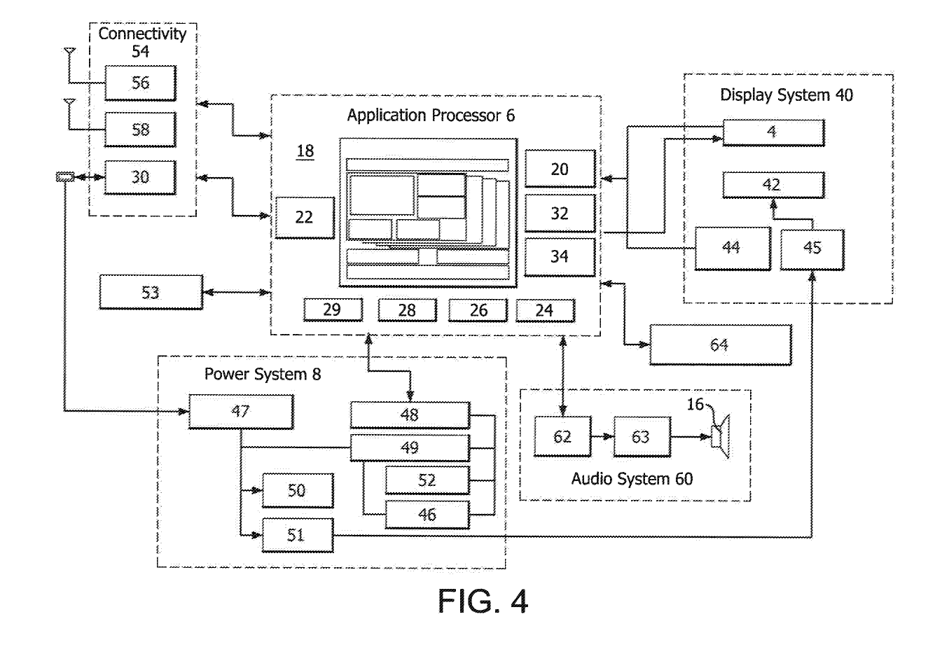

FIG. 4 illustrates specific, significant elements which assist in the operation of card 1. Application processor 6, the heart of card 1, comprises or is equivalent to an ARM Cortex A7 processor 18. This processor runs an existing OS such as iOS, Linux, Android, or equivalent. A Linux or Android OS offers the possibility of being customized for the currently proposed application. The card application executes within the OS in what is known as “kiosk” mode. In this mode, applications and settings, typically available in the OS, are made inaccessible.

Other key components of processor 6 include touch controller 20, which comprises a touch screen—an input device sensitive to pressure that is also a display screen. A resistive touch screen panel is coated with a metallic electrically resistive and conductive layer that causes a change in the electrical current which is registered when touched and sent to USB controller 22 for processing. A capacitive touch screen panel is coated with a material which stores electrical charges. When touched, a charge is drawn to the point of contact and circuits located in the panel measure that charge and then send the information to the controller to process it.

General-purpose input/output (GPIO) 24 is a generic pin on an integrated circuit whose behavior, including whether it is an input or output pin, can be controlled by the user at run time. GPIO pins have no special defined purpose, and go unused by default. Sometimes the system integrator building a full system that uses the chip finds it useful to have a handful of additional digital control lines, and having these available from the chip can avoid the effort of having to arrange additional circuitry to provide them. For example, the Realtek ALC260 chips (audio codec) have 8 GPIO pins, which go unused by default. Some system integrators (Acer Inc. laptops) employing the ALC260 use the first GPIO (GPIO0) to turn on the amplifier used for a laptop's internal speakers and external headphone jack.

Inter-integrated circuit (I²C) 26 is a multi-master, multi-slave, single-ended, serial computer bus, known today as NXP semiconductors, used for attaching low-speed peripherals to computer motherboards and embedded systems. Since Oct. 10, 2006, no licensing fees have been required to implement the I²C protocol. However, fees are still required to obtain I²C slave addresses allocated by NXP. Several competitors, such as Siemens AG (later Infineon Technologies AG, now Intel mobile communications), NEC, Texas Instruments, STMicroelectronics (formerly SGS-Thomson), Motorola (later Freescale), and Intersil, have introduced compatible I²C products to the market since the mid-1990s. SMBus, defined by Intel in 1995, is a subset of I²C that defines the protocols more strictly. One purpose of SMBus is to promote robustness and interoperability. Accordingly, modern I²C systems incorporate policies and rules from SMBus, sometimes supporting both I²C and SMBus, requiring only minimal reconfiguration.

Secure digital purpose input/output (SDIO) 28 is a nonvolatile memory card used extensively in portable devices, such as mobile phones, digital cameras, GPS navigation devices, handheld consoles, and tablet computers. The SDIO standard was introduced in August, 1999 as an evolutionary improvement over MultiMediaCards (MMC). The SDIO standard is maintained by the SD Association (SDA), SDIO technologies have been implemented in more than 400 brands across dozens of product categories and more than 8,000 models. The SDIO format 29 includes four card families available in three different form factors. The four families are the original Standard-Capacity (SDSC), the High-Capacity (SDHC), the eXtended-Capacity (SDXC), and the SDIO, which combines input/output functions with data storage. The three form factors are the original size, the mini size, and the micro size. Electrically passive adapters allow a smaller card to fit and function in a device built for a larger card. There are many combinations of form factors and devices families, although as of 2013, the prevailing formats are full or micro-size SDHC and full/micro SDXC.

Universal serial bus (USB) 30 is an industry standard developed in the mid-1990s that defines the cables, connectors and communications protocols used in a bus for connection, communication, and power supply between computers and electronic devices. USB was designed to standardize the connection of computer peripherals (including keyboards, pointing devices, digital cameras, printers, portable media players, disk drives and network adapters) to personal computers, both to communicate and to supply electric power. It has become commonplace on other devices, such as smartphones, PDAs and video game consoles, USB has effectively replaced a variety of earlier interfaces, such as serial and parallel ports, as well as separate power chargers for portable devices.

Video display controller (VDC) 32 is an integrated circuit which is the main component in a video signal generator, a device responsible for the production of a TV video signal in a computing or game system. Some VDCs also generate an audio signal, but in that case it is not their main function. VDCs were most often used in the old home-computers of the 80s, but also in some early video game systems. The VDC is always the main component of the video signal generator logic, but sometimes there are also other supporting chips used, such as RAM to hold the pixel data, ROM to hold character fonts, or perhaps some discrete logic such as shift registers which were necessary to build a complete system. In any case, it is the VDC's responsibility to generate the timing of the necessary video signals, such as the horizontal and vertical synchronization signals, and the blanking interval signal. Most often, the VDC chip is completely integrated into the logic of the main computer system, (its video RAM appears in the memory map of the main CPU), but sometimes it functions as a coprocessor that can manipulate the video RAM contents independently.

Graphics processing unit (GPU) 34, also occasionally called visual processing unit (VPU), is a specialized electronic circuit designed to rapidly manipulate and alter memory to accelerate the creation of images in a frame buffer intended for output to a display. GPUs are used in embedded systems, mobile phones, personal computers, workstations, and game consoles. Modern GPUs are very efficient at manipulating computer graphics and image processing, and their highly parallel structure makes them more effective than general-purpose CPUs for algorithms where processing of large blocks of data is done in parallel. In a personal computer, a GPU can be present on a video card, or it can be on the motherboard or, in certain CPUs, on the CPU die. The term GPU was popularized by Nvidia in 1999, which marketed the GeForce 256 as “the world's first ‘GPU’, or Graphics Processing Unit, a single-chip processor with integrated transform, lighting, triangle setup/clipping, and rendering engines that are capable of processing a minimum of 10 million polygons per second”. Rival ATI Technologies coined the term visual processing unit or YPU with the release of the Radeon 9700 in 2002.

Display system 40 comprises touchscreen 4, having the size and dimension of a business card. It is custom-built for card 1. The screen has a resolution yet to be defined, but would be similar to what is found today on smart phones and iPads. Design considerations will take into account the need for displaying images and videos. As is typical of most mobile devices, the display will be backlight 42 via LED technology, including LED driver 45. A backlight is a form of illumination used in liquid crystal displays (LCDs). As LCDs do not produce light themselves (unlike, for example cathode ray tube (CRT) displays), they need illumination (ambient light or a special light source) to produce a visible image. Backlights illuminate the LCD from the side or back of the display panel, unlike frontlights, which are placed in front of the LCD. Backlights are used in small displays to increase readability in low light conditions, such as in wristwatches, and are used in computer displays and LCD televisions to produce light in a manner similar to a CRT display.

Ambient light sensor 44 is included so that the backlighting intensity can be controlled in relation to the brightness of the environment in which it operates.

TFT LCD or thin film transistor is a type of technology used to improve the image quality of an LCD. Each pixel on a TFT-LCD has its own transistor on the glass itself, which offers more control over the images and colors that it renders.

There exists today numerous power system 8 solutions that would be applicable to card 1. It is contemplated that power system 47 of card 1, including backlight power 51, will be powered by a lithium-ion (Li-Ion) battery 46 with a battery life similar to a smart phone. Like many smart phones, the design would likely assume that the battery would not be user-accessible. Charging of the device will at first be done via USB 30, but follow-on options may include a separate Class 2, UL listed, 3^{rd} party “wall-wart” charger.

Battery management system 48 comprises an electronic system that manages a rechargeable battery (cell or battery pack), such as by protecting the battery from operating outside its safe operating area, monitoring its state, calculating secondary data, reporting that data, controlling its environment, authenticating it and/or balancing it. A battery pack built together with a battery management system with an external communication data bus is a smart battery pack. A smart battery pack must be charged by a smart battery charger 49. Fuel gauge 52 is provided to measure fuel consumption, if fuel is used to power the system.

Processor power 50 is often known as CPV power, CPU cycles, and various other names. Processing power is the ability of a computer to manipulate data. Processing power varies with the architecture (and clock speed) of the CPU—usually CPUs with higher clock speeds and those supporting larger word sizes have more processing power than slower CPUs supporting smaller word sizes.

LPDDR memory 53, the original low-power DDR (sometimes, in hindsight, called LPDDR1) is a slightly modified form of DDR SDRAM, with several changes to reduce overall power consumption. Most significant, the supply voltage is reduced from 2.5 to 1.8 V. Additional savings come from temperature-compensated refresh (DRAM requires refresh less often at low temperatures), partial array self refresh, and a “deep power down” mode which sacrifices all memory contents. Additionally, chips are smaller, using less board space than their non-mobile equivalents. Samsung and Micron are two of the main providers of this technology, which is used in tablet computing devices such as the Apple iPad, Samsung Galaxy Tab and Motorola Droid X.

Connectivity 54 is provided by wireless technologies, such as Bluetooth® 56, WiFi 58, and others. Card 1 will be updated with informational content as well as operational software via these wireless systems. These technologies, being short-range in nature, will require local connectivity with PC and wireless router equipment. Bluetooth® provides a host of connectivity features, but primarily, for this application, provides for remote audio via a Bluetooth®-connected headset. USB 30 is yet another consideration for interconnectivity, as its planned use for battery charging is already within the scope of the design. Cellular connectivity may be considered as a design option at a later date if deemed economically feasible, as there is a cost associated with the required cellular service.

Card 1 also includes audio system 60, including an on-board piezo-type speaker 16 similar to and typically found in hand-held electronics devices and amplifier 63. The inclusion of audio allows information conveyance in addition to the information displayed on the LCD screen. Audio codec 62 is a device or computer program capable of coding or decoding a digital data stream of audio. In software, an audio codec is a computer program implementing an algorithm that compresses and decompresses digital audio data according to a given audio file format or streaming media audio format.

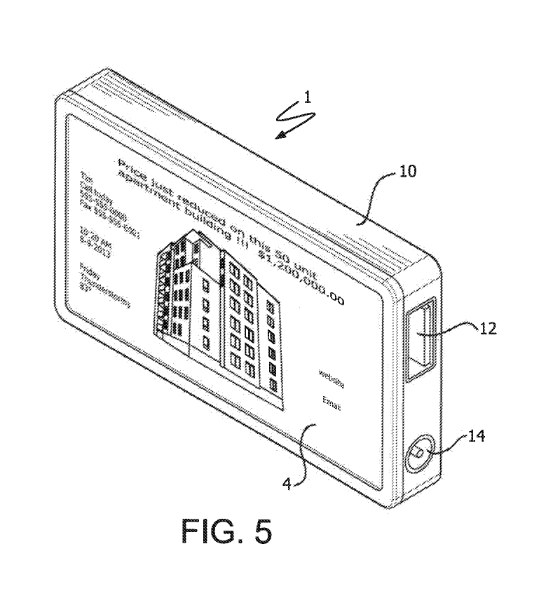

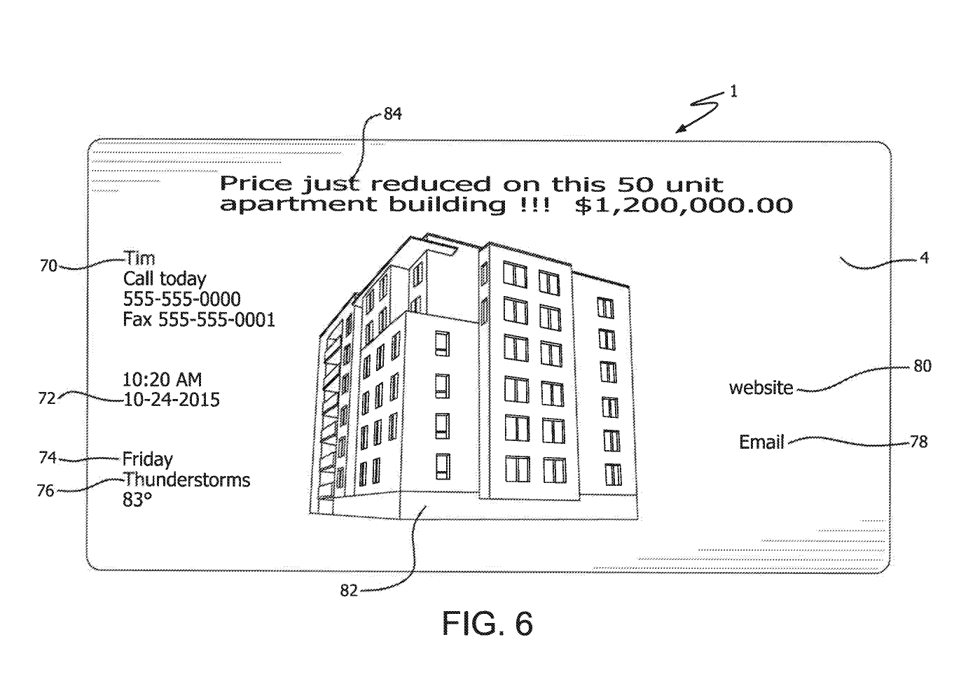

Standard power and status LEDs and user switches 64 are also provided in the system. FIGS. 5 and 6 illustrate an example of a typical informational card 1 display showing, for instance, contact information 70, current dates and times 72, days of the week 74, weather 76, email contacts 78, websites 80, etc. The internet is accessible via card 1. Photographs and videos 82 are available. Card 1 itself can change colors and change to a different language. Significantly, digital business card 1 is designed to keep the individual informed of all current information 84, as it is constantly being updated.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A hand-held sized portable electronic digital business card configured to receive data and information from a wireless interne system, said business card comprising:
a front housing and a back housing;
a touch screen LCD located behind the front housing;
an application processor for receiving and processing current information received from the wireless system, said application processor being located between the front housing and back housing; and
a power system located between the front and back housing for providing electrical power to the application processor.

2. The digital business card as in claim 1 wherein the power system includes a lithium ion battery.

3. The digital business card as in claim 1 wherein the wireless system a Bluetooth® system.

4. The digital business card as in claim 1 wherein the wireless system is a wi-fi system.

5. The digital business card as in claim 1 wherein the rear housing comprises a battery charger.

6. The digital business card as in claim 1 Wherein the rear housing comprises a USB port.

7. The digital business card as in claim 1 wherein the rear housing comprises an audio speaker.

8. The digital business card as in claim 1 further comprising a display system which includes a touch screen LCD, an audio system which includes an audio speaker, and a connectivity system which incudes the wireless system.
